(19) United States
(12) Patent Application Publication
(10) Pub. No.: US 2022/0403933 A1
(43) Pub. Date: Dec. 22, 2022

(54) PRESSURE EQUILIBRATING SEALING SYSTEM

(71) Applicant: Trelleborg Sealing Solutions US, Inc., Fort Wayne, IN (US)

(72) Inventors: Ronald G. Garrett, Brighton, CO (US); Eric R. Stoisits, Houston, TX (US); Eric C. Bucci, Houston, TX (US)

(73) Assignee: Trelleborg Sealing Solutions US, Inc., Fort Wayne, IN (US)

(21) Appl. No.: 17/349,415

(22) Filed: Jun. 16, 2021

(51) Int. Cl. F16J 15/00; F16J 15/3236; F16J 15/3208

(52) U.S. Cl. CPC F16J 15/006; F16J 15/3236; F16J 15/3208

(57) ABSTRACT

A sealing system includes: a first seal including at least one first seal lip sealing against a first surface and a second surface and having a first cavity filled with a first energizer forcing the at least one first seal lip against the first surface and the second surface, the first cavity facing a first pressure region; and a second seal spaced from the first seal and having at least one second seal lip sealing against the first surface and the second surface, the second seal including a second cavity filled with a second energizer forcing the at least one second seal lip against the first surface and the second surface to separate a second pressure region from a third pressure region. The at least one second seal lip is configured to deform such that fluid pressures in the first, second, and third pressure regions equalize.

### BACKGROUND OF THE INVENTION

### 1. Field of the Invention

The present invention relates to sealing systems, and, more particularly, to sealing systems that can be used in high-pressure applications.

### 2. Description of the Related Art

Sealing systems are known for sealing regions between two parts. In many sealing systems, especially those for high-pressure applications, systems with two or more seals not in separate grooves are prone to damage. The high pressure acting on the seals can lead to irreversible deformation of the seal, which can reduce sealing efficiency and/or lead to the seal being unable to form a suitable seal. The cost and space associated with having separate grooves is undesirable.

What is needed in the art is a sealing system that is resistant to damage in high-pressure sealing environments.

### SUMMARY OF THE INVENTION

The present invention provides a sealing system with a first seal and a second seal that can deform to allow pressurized fluid to flow between different pressure regions and equalize the fluid pressure in the pressure regions.

The invention in one form is directed to a sealing system including: a first part including a first surface; a second part including a second surface; a first seal including at least one first seal lip sealing against the first surface and the second surface, the first seal having a first cavity filled with a first energizer forcing the at least one first seal lip against the first surface and the second surface, the first cavity facing a first pressure region; and a second seal spaced from the first seal and including at least one second seal lip sealing against the first surface and the second surface, the second seal including a second cavity filled with a second energizer forcing at least one second seal lip against the first surface and the second surface, the second cavity facing a second pressure region between the second seal and the first seal. The at least one second seal lip separates the second pressure region from a third pressure region on an opposite side of the at least one second seal lip and is configured to deform and allow pressurized fluid from the third pressure region into the second pressure region such that fluid pressures in the first pressure region, the second pressure region, and the third pressure region equalize.

The invention in another form is directed to a method of forming a sealing system. The method includes: placing a first seal between a first surface and a second surface so at least one first seal lip seals against the first surface and the second surface, the first seal includes a first cavity filled with a first energizer forcing the at least one first seal lip against the first surface and the second surface, the first cavity facing a first pressure region; placing a second seal between the first surface and the second surface so at least one second seal lip seals against the first surface and the second surface, the second seal including a second cavity filled with a second energizer forcing the at least one second seal lip against the first surface and the second surface, the second cavity facing a second pressure region between the second seal and the first seal, the at least one second seal lip separating the second pressure region from a third pressure region on an opposite side of the at least one second seal lip; and displacing the first seal toward the second seal so pressurized fluid in the third pressure region deforms the at least one second seal lip to allow pressurized fluid from the third pressure region into the second pressure region such that fluid pressures in the first pressure region, the second pressure region, and the third pressure region equalize.

An advantage of the present invention is equalization of the fluid pressures in the first pressure region, the second pressure region, and the third pressure region causes the seals to experience little net pressure, reducing the risk of damage to the seals.

Another advantage is the seals of the sealing system can be provided with a variety of different energizers to provide varied sealing behavior.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a cross-sectional view of an exemplary embodiment of a sealing system provided according to the present invention;

FIG. 2 is a cross-sectional view of another exemplary embodiment of a sealing system provided according to the present invention;

FIG. 3 is a cross-sectional view of another exemplary embodiment of a sealing system provided according to the present invention;

FIG. 4 is a cross-sectional view of another exemplary embodiment of a sealing system provided according to the present invention; and

FIG. 5 is a flow chart illustrating an exemplary embodiment of a method of forming a sealing system provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

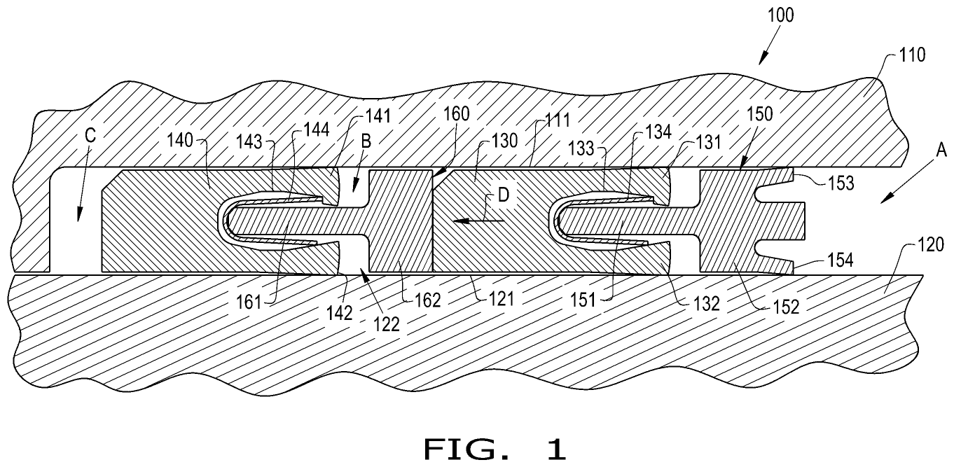

Referring now to the drawings, and more particularly to FIG. 1, there is shown an exemplary embodiment of a sealing system 100 provided according to the present invention which generally includes a first part 110, a second part 120, a first seal 130, and a second seal 140 spaced from the first seal 130. The first part 110 has a first surface 111 and the second part 120 has a second surface 121, with a sealed space 122 formed between the first surface 111 and the second surface 121. The first seal 130 and the second seal 140 are disposed in the sealed space 122 so at least one first lip, illustrated as a pair of first seal lips 131, 132, of the first seal 130 seal against the first surface 111 and the second surface 121 and at least one second lip, illustrated as a pair of second seal lips 141, 142, of the second seal 140 seal against the first surface 111 and the second surface 121. While each of the seals 130, 140 is illustrated and described as having a respective seal lip 131, 141 that seals against the first surface 111 and another respective seal lip 132, 142 that seals against the second surface 121, in some embodiments each seal 130, 140 may have only a single seal lip that seals against both the first surface 111 and the second surface 121 or, alternatively, may have more than two seal lips.

The first seal 130 has a first cavity 133 that is filled with a first energizer 134 forcing the first seal lips 131, 132 into the first surface 111 and the second surface 121, respectively, and the second seal 140 has a second cavity 143 that is filled with a second energizer 144 forcing the second seal lips 141, 142 into the first surface 111 and the second surface 121, respectively. While the first energizer 134 and the second energizer 144 are described herein as “filling” their respective cavity 133, 143, the energizers do not need to entirely fill the cavity 133, 143, as illustrated. Each energizer 134, 144 may be in the form of a spring, such as a V-spring as illustrated. The energizers 134, 144 force the seal lips 131, 132, 141, 142 against the first surface 111 and the second surface 121 to maintain the sealed space 122. In some embodiments, the first seal 130 and the second seal 140 are substantially identical, i.e., the first seal 130 and the second seal 140 have generally the same shape and dimensions.

The first cavity 133 of the first seal 130 faces a first pressure region A and the second cavity 143 of the second seal 143 faces a second pressure region B, which is between the second seal 140 and the first seal 130. The second seal lips 141, 142 separate the second pressure region B from a third pressure region C that is on an opposite side of the second seal lips 141, 142. In this respect, the second pressure region B is the region sealed between the first pressure region A by the first seal lips 131, 132 and the third pressure region C by the second seal lips 141, 142. In some embodiments, the first seal 130 only contacts the first surface 111 and the second surface 121 at the first seal lips 131, 132 and the second seal 140 only contacts the first surface 111 and the second surface 121 at the second seal lips 141, 142. It should be appreciated that the illustrated seal lips 131, 132, 141, 142 are exemplary only and other shapes of seal lips may be utilized according to the present invention for sealing. When the sealing system 100 is pressurized, the first pressure region A may experience increased fluid pressure. The increased fluid pressure is transmitted to the first seal 130, which may also be referred to as a “primary seal,” which could make the first seal 130 and/or the second seal 140 susceptible to damage if the first seal 130 pushes too much into the second seal 140 from the movement caused by pressure on the first seal 130.

To reduce the risk of the first seal 130 and/or the second seal 140 being damaged, at least one second seal lip (the second seal lips 141, 142) is configured to deform and allow pressurized fluid from the third pressure region C into the second pressure region B such that fluid pressures in the first pressure region A, the second pressure region B, and the third pressure region C equalize. To accomplish this, the first seal 130 may displace in a direction D toward the second seal 140 due to increased fluid pressure in the first pressure region A. As the first seal 130 displaces toward the second seal 140, the first seal 140 may abut against an element, such as a second hat ring 160 described further herein, which also causes the second seal 140 to displace in the direction D. In some embodiments, the first seal 130 and the second seal 140 do not contact one another.

As the second seal 140 displaces in the direction D, the fluid in the third pressure region C is compressed, which increases the fluid pressure in the third pressure region C. Upon the fluid pressure in the third pressure region C reaching a threshold value, the second seal lips 141, 142 deform and allow pressurized fluid from the third pressure region C into the second pressure region B, increasing the fluid pressure in the second pressure region B. Thus, the displacement of the first seal 130 in the direction D can only occur so long as the fluid pressure in the first pressure region A is greater than the fluid pressures in the second pressure region B and the third pressure region C. Once the fluid pressures in the pressure regions A, B, C equalize, displacement of the first seal 130 and the second seal 140 ceases. The equalized fluid pressure in the pressure regions A, B, C causes the seals 130, 140 to “float”, so there is little, if any, net fluid pressure acting on the seals 130, 140, which reduces the risk of the fluid pressure damaging the seals 130, 140 while still allowing the seals 130, 140 to effectively seal the space. In this respect, the seals 130, 140 displacing in the direction D toward the third pressure region C to increase the fluid pressure in the third pressure region C, in combination with the seal lips 141, 142 allowing pressurized fluid to flow from the third pressure region C into the second pressure region B, allows equalization of the fluid pressures in the pressure regions A, B, C to reduce the risk of damage to the seals 130, 140.

As previously described, the second seal lips 141, 142 may be adjusted in a variety of ways. In order to deform and allow pressurized fluid from the third pressure region C into the second pressure region B, the material(s) and the geometry of the second seal lips 141, 142 can be adjusted based on a variety of criteria, including but not limited to expected operating pressures and the force exerted on the second seal lips 141, 142 by the second energizer 144. The geometry of the second seal lips 141, 142 is highly relevant because the pressurized fluid from the third pressure region C must be directed in a manner that brings the second seal lips 141, 142 out of contact with the respectively sealed surface 111, 121. For example, the second seal lips 141, 142 may have a low gradient from back to front in the contact stress profile to allow the increased pressure from the third pressure region C to deform the second seal lips 141, 142 sufficiently to separate the second seal lips 141, 142 from the respectively sealed surface 111, 121 and allow the pressurized fluid to flow from the third pressure region C into the second pressure region B.

In some embodiments, the sealing system 100 includes a first hat ring 150 and the previously described second hat ring 160. The first hat ring 150 may include a first section 151 that is disposed in the first cavity 133 of the first seal 130 and a second section 152 disposed outside of the first cavity 133. The first section 151 may, for example, be in contact with the first energizer 134 disposed in the first cavity 133. The second section 152, on the other hand, may define a greater diameter than the first section 151 and include at least one hat lip, illustrated as a pair of hat lips 153, 154, sealing against the first surface 111 and the second surface 121, respectively. The hat lip(s) 153, 154 may separate the first pressure region A from the space in which the first section 151 is disposed. In some embodiments, the first hat ring 150 only contacts the first surface 111 and the second surface 121 at the hat lip(s) 153, 154 so there is a clearance defined between the first hat ring 150 and the surfaces 111, 121. In other words, the first hat ring 150 may contact the first surface 111 and the second surface 121.

The second hat ring 160, similarly to the first hat ring 150, may include a first section 161 disposed in the second cavity 143 of the second seal 140 and a second section 162 disposed outside of the second cavity 143. The first section 161 may, for example, contact the second energizer 144 disposed in the second cavity 143. In some embodiments, the second section 162 of the second hat ring 160 does not contact the first surface 111 and/or the second surface 121. In some embodiments, such as the illustrated embodiment, the second section 162 of the second hat ring 160 does not contact the first surface 111 or the second surface 121 and the second hat ring 160 does not contact the first surface 111 or the second surface 121. In this respect, in some embodiments a clearance is formed between the first surface 111 and/or the second surface 121 and an entirety of the second hat ring 160 so pressurized fluid can flow past the second hat ring 160. In some embodiments, the second section 162 of the second hat ring 160 abuts against the first seal 130 so displacement of the first seal 130 in the direction D can cause a similar displacement of the second seal 140 in the direction D; similarly, displacement of the second seal 140 in a direction opposite to the direction D can cause displacement of the first seal 130 in the same direction due to the abutment of the second section 162 against the first seal 130.

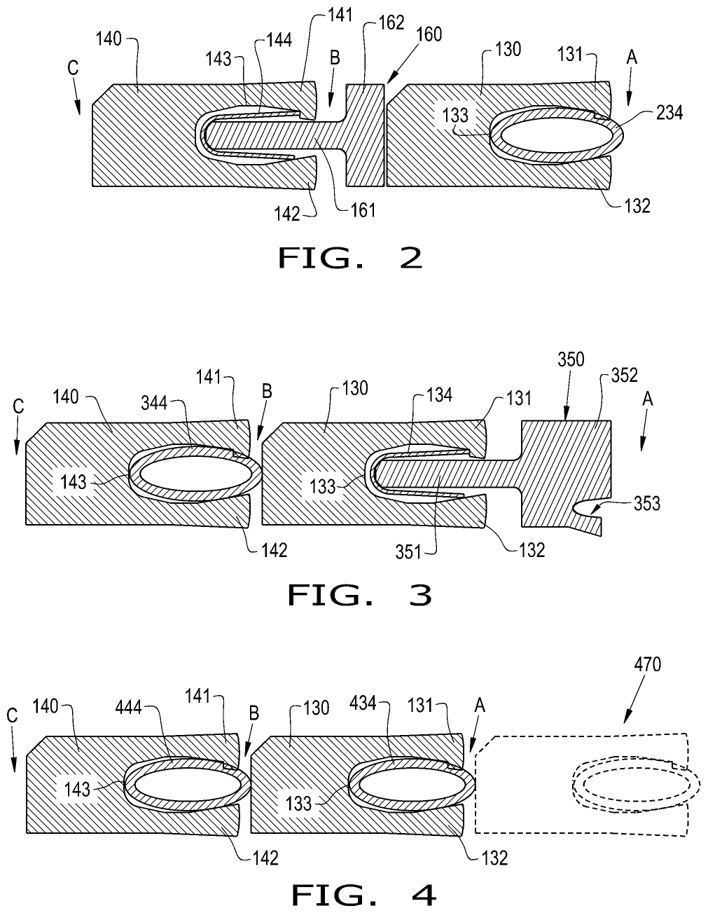

While the exemplary embodiment of the sealing system 100 illustrated in FIG. 1 includes a pair of hat rings 150, 160, in some embodiments only a single hat ring is provided. Referring now to FIG. 2, the first seal 130 and the second seal 140 are illustrated with the second hat ring 160 having the first section 161 disposed in the second cavity 143 of the second seal 140 and the second section 162 abutting against the first seal 130 but no hat ring is disposed in the first cavity 133 of the first seal 130. Rather, an energizer 234 is disposed in the first cavity 133 in the form of a slant coil spring, instead of a V-spring, as illustrated. As opposed to the first energizer 134 in the form of a V-spring illustrated in FIG. 1, which has an open cross-section and can accept a section of a hat ring, the slant coil spring 234 illustrated in FIG. 2 has a closed cross-section and closes the first cavity 133 so the first cavity 133 cannot accept a portion of a hat ring. Using a slant coil spring can provide a different spring curve with different friction and leakage characteristics, which, in some embodiments, may make it easier for the second seal lips 141, 142 to deform and allow pressurized fluid from the third pressure region C into the second pressure region B. However, operation of the first seal 130 and the second seal 140 with the second hat ring 160 and the slant coil spring 234 of FIG. 2 is similar to when two hat rings are incorporated, as illustrated in FIG. 1, so further description is omitted.

In some embodiments, and referring now to FIG. 3, the first seal 130 and the second ring 140 are provided with a single hat ring in the form of a scraper hat ring 350 having a first section 351 disposed in the first cavity 133 of the first seal 130 and a second section 352 disposed outside of the first cavity 133 and including one or more scraper lips 353, illustrated as a single scraper lip 353, that contacts the first surface 111 or the second surface 121. Incorporating the scraper lip 353 may provide a buffer seal to address pressure spikes that may damage the first seal 130 (the primary seal), provide some flow control, and also offer contaminant ingress protection to reduce the risk of contaminants damaging the first seal lips 131, 132 of the first seal 130. The first section 351 of the scraper hat ring 350 may contact the first energizer 134, which is in the form of a V-spring. A second energizer 344 in the form of a slant coil spring may be disposed in the second cavity 143 of the second seal 140, rather than a V-spring as illustrated in FIGS. 1-2. To transmit displacement between the first seal 130 and the second seal 140, the slant coil spring 344 disposed in the second cavity 143 may have a portion that extends outside the second cavity 143 and abuts against the first seal 130.

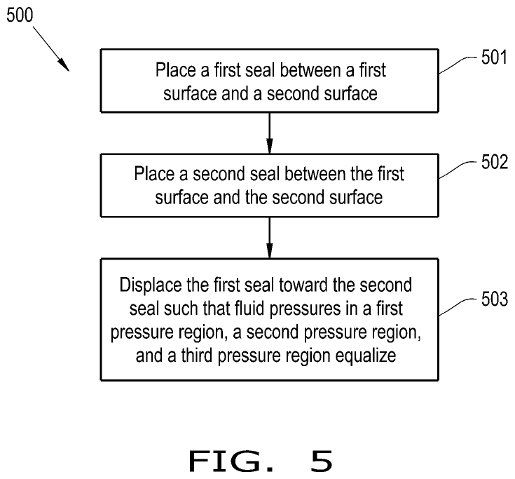

In some embodiments, and referring now to FIG. 4, the sealing system 100 does not include any hat rings. As illustrated, the first seal 130 may have a first energizer in the form of a slant coil spring 434 disposed in the first cavity 133 and the second seal 140 may have a second energizer that is also in the form of a slant coil spring 444 disposed in the second cavity 143. The slant coil spring 444 disposed in the second cavity 143 may have a portion that is disposed outside of the second cavity 143 and abuts against the first seal 130, maintaining the space between the first seal 130 and the second seal 140 and allowing displacement of the first seal 130 to cause a corresponding displacement of the second seal 140. It should be appreciated that while only two seals 130, 140 are illustrated and described previously, additional seals, which may or may not be substantially identical to the seals 130, 140, can be added to the sealing system 100 for redundancy and the additional seal(s) would operate similarly to equalize the fluid pressure in the pressure regions.

Referring still to FIG. 4, an optional third seal 470, illustrated in dashed lines, is illustrated that is identical to the first seal 130 and the second seal 140. The slant coil spring 434 disposed in the first cavity 133 may have a portion disposed outside of the first cavity 133 that abuts against the third seal 470, allowing displacement of the third seal 470, which may be the primary seal, to cause a corresponding displacement of the first seal 130 and the second seal 140. In this respect, the fluid pressure in the sealing system would equalize similarly to when there are only two seals in the system, with the primary difference being that the fluid pressure causing the initial displacement of the seals 130, 140, 470 would act on the third seal 470 rather than the first seal 130. Thus, the third seal 470, and additional seals if desired, can be added to the sealing system for redundant sealing.

From the foregoing, it should be appreciated that the sealing system 100 provided according to the present invention has a first seal 130 and a second seal 140 with one or more second seal lips 141, 142 that can deform and allow pressurized fluid from a third pressure region C into a second pressure region B to equalize the fluid pressure between the different pressure regions A, B, C. The end result of the fluid pressure equalizing is that the seals 130, 140 have little, if any, net pressure acting thereon, which can reduce the risk of the seals 130, 140 being damaged. It should be further appreciated that the sealing system 100 can be provided with many different combinations of hat rings and energizers, which allows flexibility to tailor the sealing system to specific applications and sealing requirements. The sealing system 100 provided according to the present invention thus provides a robust sealing system that is less prone to damage than known sealing systems.

Referring now to FIG. 5, an exemplary embodiment of a method 500 of forming the sealing system 100 provided according to the present invention is illustrated. The method 500 includes placing 501 the first seal 130 between the first surface 111 and the second surface 121 so the at least one first seal lips 131, 132 seals against the first surface 111 and the second surface 121 and placing 502 the second seal 140 between the first surface 111 and the second surface 121 so at least one second seal lip 141, 142 seals against the first surface 111 and the second surface 121. The method 500 further includes displacing 503 the first seal 130 toward the second seal 140 so pressurized fluid in the third pressure region C deforms the second seal lip(s) 141, 142 to allow pressurized fluid from the third pressure region C into the second pressure region B such that fluid pressures in the first pressure region A, the second pressure region B, and the third pressure region C equalize. It should be appreciated that the method 500 may be used to form the sealing system 100 with any combination of energizers and/or hat rings previously described. In some embodiments, displacing 503 the first seal 130 includes displacing the third seal 470 toward the first seal 130, as previously described in the context of FIG. 4.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sealing system, comprising:
a first part comprising a first surface;
a second part comprising a second surface;
a first seal comprising at least one first seal lip sealing against the first surface and the second surface, the first seal comprising a first cavity filled with a first energizer forcing the at least one first seal lip against the first surface and the second surface, the first cavity facing a first pressure region; and
a second seal spaced from the first seal and comprising at least one second seal lip sealing against the first surface and the second surface, the second seal comprising a second cavity filled with a second energizer forcing the at least one second seal lip against the first surface and the second surface, the second cavity facing a second pressure region between the second seal and the first seal, the at least one second seal lip separating the second pressure region from a third pressure region on an opposite side of the at least one second seal lip, the at least one second seal lip being configured to deform and allow pressurized fluid from the third pressure region into the second pressure region such that fluid pressures in the first pressure region, the second pressure region, and the third pressure region equalize.

2. The sealing system of claim 1, further comprising:
a first hat ring comprising a first section disposed in the first cavity and a second section disposed outside of the first cavity, the second section comprising at least one hat lip sealing against the first surface and the second surface; and
a second hat ring comprising a first section disposed in the second cavity and a second section disposed outside of the second cavity, the second section of the second hat ring not contacting at least one of the first surface or the second surface.

3. The sealing system of claim 2, wherein the second hat ring abuts against the first seal.

4. The sealing system of claim 2, wherein the first seal and the second seal are substantially identical.

5. The sealing system of claim 2, wherein the second section of the first hat ring comprises a pair of hat lips.

6. The sealing system of claim 1, wherein the first energizer comprises a slant coil spring and the second energizer comprises a V-spring.

7. The sealing system of 6, further comprising a hat ring comprising a first section disposed in the second cavity and a second section abutting against the first seal and not contacting at least one of the first surface or the second surface.

8. The sealing system of claim 6, wherein the slant coil spring closes the cavity.

9. The sealing system of claim 1, wherein the first energizer is a V-spring and the second energizer is a slant coil spring.

10. The sealing system of claim 9, wherein the slant coil spring abuts against the first seal.

11. The sealing system of claim 9, further comprising a hat ring comprising a first section disposed in the first cavity and a second section comprising a scraper lip contacting the first surface or the second surface.

12. The sealing system of claim 1, wherein the first energizer and the second energizer each comprise a slant coil ring.

13. The sealing system of claim 12, wherein the second energizer abuts against the first seal.

14. The sealing system of claim 1, wherein the first seal and the second seal do not contact one another.

15. The sealing system of claim 1, wherein the first seal only contacts the first surface and the second surface at the at least one first seal lip and the second seal only contacts the first surface and the second surface at the at least one second seal lip.

16. The sealing system of claim 1, wherein the at least one first seal lip comprises a pair of first lips and the at least one second seal lip comprises a pair of second seal lips, one of the first seal lips sealing against the first surface, the other of the first seal lips sealing against the second surface, one of the second seal lips sealing against the second surface, and the other of the second seal lips sealing against the second surface.

17. A method of forming a sealing system, the method comprising:
placing a first seal between a first surface and a second surface so at least one first seal lip seals against the first surface and the second surface, the first seal comprising a first cavity filled with a first energizer forcing the at least one first seal lip against the first surface and the second surface, the first cavity facing a first pressure region;
placing a second seal between the first surface and the second surface so at least one second seal lip seals against the first surface and the second surface, the second seal comprising a second cavity filled with a second energizer forcing the at least one second seal lip against the first surface and the second surface, the second cavity facing a second pressure region between the second seal and the first seal, the at least one second seal lip separating the second pressure region from a third pressure region on an opposite side of the at least one second seal lip; and
displacing the first seal toward the second seal so pressurized fluid in the third pressure region deforms the at least one second seal lip to allow pressurized fluid from the third pressure region into the second pressure region such that fluid pressures in the first pressure region, the second pressure region, and the third pressure region equalize.

18. The method of claim 17, wherein the sealing system further comprises:
a first hat ring comprising a first section disposed in the first cavity and a second section disposed outside of the first cavity, the second section comprising at least one hat lip sealing against the first surface and the second surface; and
a second hat ring comprising a first section disposed in the second cavity and a second section disposed outside of the second cavity, the second section of the second hat ring not contacting at least one of the first surface or the second surface.

19. The method of claim 17, wherein the first seal and the second seal are substantially identical.

20. The method of claim 17, wherein the first seal only contacts the first surface and the second surface at the at least one first seal lip and the second seal only contacts the first surface and the second surface at the at least one second seal lip.
